(19) United States
(12) Patent Application Publication
(10) Pub. No.: US 2006/0046104 A1
(43) Pub. Date: Mar. 2, 2006

(54) Balanced lithium ion battery

(76) Inventor: Albert H. Zimmerman, Torrance, CA (US)

Correspondence Address: Carole A. Mulchinski;M1/040, The Aerospace Corporation, 2350 East El Segundo Blvd., El Segundo, CA, 90245, US

(21) Appl. No.: 10/929,970

(22) Filed: Aug. 30, 2004

(51) Int. Cl. H01M 10/00

(52) U.S. Cl. 429/7; 429/149

(57) ABSTRACT

A battery system uses passive nonlinear electronic devices, such as zener diodes, respectively connected in parallel to each of the serially connected battery cells, such as lithium ion battery cells, connected in a string, to maintain all of the cells at a balanced state of charge, and will automatically correct any initial imbalance in the states of charge of individual cells. The passive nonlinear devices are preferably matched to equally force each battery cell to have an exponentially rising rate of internal capacity loss as cell voltage increases, while keeping cell voltages and capacities matched. The devices will not accelerate open circuit losses of the cells as the cells become fully discharged as a consequence of conducting low currents compared to the cell charge and discharge currents without generating excessive heat for improved safety.

### STATEMENT OF GOVERNMENT INTEREST

The invention was made with Government support under contract No. F04701-00-C-0009 by the Department of the Air Force. The Government has certain rights in the invention.

### FIELD OF THE INVENTION

The invention relates to the field of electrical battery systems. More particularly, the present invention relates to ion lithium battery cells balanced in an integrated battery.

### BACKGROUND OF THE INVENTION

Lithium-ion battery cells having been connected in a serial string to make a battery. The state of charge of each of the cells can disadvantageously change as the battery is operated or allowed to stand unused over long periods of time. Most batteries maintain the individual cells in a balanced condition through the use of overcharge to bring all the cells up to a highly charged state. The use of overcharging depends on monotonically rising internal losses as the cell state of charge increases. However, lithium-ion cells do not exhibit monotonically increasing losses as the cells are charged to higher states of charge. Lithium ion battery cells do not generally tolerate overcharge without being degraded.

A number of methods have been used in the battery industry to keep individual cells balanced. Voltage regulators are sometimes placed across each cell in the battery to hold the individual cells at a prescribed voltage by shunting any unneeded current around the cell as recharge occurs. Relays have been used to bypass unneeded current around individual cells when a prescribed voltage level is attained. Relays have also been used to switch balancing load resistors onto any cells that rise over a set threshold above the average cell voltage. These relays have been activated either manually as needed, or by differential voltage sensing circuits in the battery. All these methods work well, but require significant active electronic circuitry to always be powered for the purpose of maintaining the battery state of health. A fully passive method involves the placement of appropriately sized resistors in parallel with each battery cell, thus providing linearly rising losses with increasing cell voltage. One disadvantage of the parallel resistor method is that the method can fully discharge the battery, which can damage lithium-ion cells when the battery is left in an unused or open-circuit state. Another disadvantage of the parallel resistor method is the extremely slow rebalancing of the cells. These and other disadvantages are solved or reduced using the invention.

### SUMMARY OF THE INVENTION

An object of the invention is to provide a battery system having balanced lithium ion battery cells.

Another object of the invention is to provide a battery system having balanced lithium ion battery cells each having a pair of terminals across which is coupled a passive nonlinear device.

Yet another object of the invention is to provide a battery system having balanced lithium ion battery cells each having a pair of terminals across which is coupled a passive nonlinear diode.

Still another object of the invention is to provide a lithium ion battery system having a series of balanced lithium ion battery cells each having a pair of terminals across which is coupled a respective passive nonlinear device.

The invention is directed to a multicell battery system having a nonlinear device coupled across respective battery cells. In the preferred form, the battery cells are lithium ion battery cells and the nonlinear device is a passive diode. The diodes serve to balance charge and discharge currents. The diodes are passive components assuring cell change balance without the use of active components and monitoring systems. The passive device preferably has an exponential current-voltage (IV) curve and is placed in parallel with each battery cell. The IV curve preferably has leakage current below the cell self-discharge rate of ˜C/100,000 in the 2.8 to 3.0 volt range where the cell is fully discharged, and should pass currents on the order of C/1,000 at the maximum expected cell operating voltage that is typically 4.1 to 4.2 volts. Preferably, the balancing devices used for all cells have IV curves that are matched. The use of balancing devices having such nonlinear characteristics will not cause cells to become depleted when the battery is left open-circuited, and can correct for cell imbalances. These and other advantages will become more apparent from the following detailed description of the preferred embodiment.

### BRIEF DESCRIPTION OF THE DRAWINGS

FIG. 1 is a schematic of a lithium ion battery.

FIG. 2 is graph of ideal and actual device current-voltage (IV) performance.

FIG. 3 is a graph of rebalancing voltages in lithium ion cells of a lithium ion battery.

### DETAILED DESCRIPTION OF THE PREFERRED EMBODIMENTS

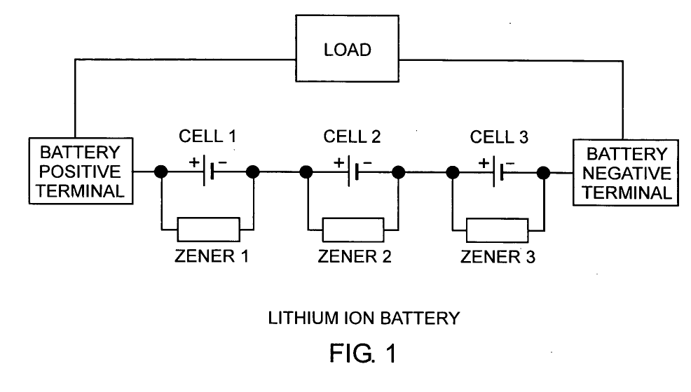

An embodiment of the invention is described with reference to the figures using reference designations as shown in the figures. Referring to FIG. 1, a schematic diagram shows balancing devices, such as zener diode 1, zener diode 2, and zener diode 3, placed in parallel with each respective battery cell, cell 1, cell 2, and cell 3, in a multicell battery. In the general form, the balancing devices are nonlinear passive electrical devices having a positive and a negative terminal. The positive terminal is connected to the positive terminal of the cell, and the negative terminal to the negative cell terminal. The cells are preferably lithium ion battery cells. The exemplar battery is shown having three cells connected in series in a serial string, but the string could be any number or a plurality of like cells and like balancing devices. It should also be apparent that multiple serial strings, each of any number of a plurality of serial cells and respective balancing devices could be connected in parallel to the first serial string for additional energy capacity of the battery. That is, the battery may consist of any number of parallel-connected strings of serial lithium ion battery cells.

The battery has a positive terminal and a negative terminal that is typically connected to a load during operational use of the battery. The load tends to draw energy from the battery. The load could further include a charger, not shown, for charging the battery. Each cell has a matched balancing device placed across positive and negative terminals of the cells. Thereafter, the battery can be charged and discharged with no noticeable changes in performance as a result of the balancing devices, unless the cells in the battery develop a persistent imbalance in voltage. When a persistent imbalance in voltage exists, the higher voltage cells will preferentially leak current through the respective balancing devices, thus being restored to the same state of charge as the other lower voltage cells. Because the balancing devices are designed to pass very low discharge current at voltages below about 3.0 volts, such as when the battery is left in an open circuited condition for a lengthy period of time, for example, over a ten-month period, each cell will discharge in a balanced manner through the balancing devices, down to approximately 3.0 volts. Any further cell discharge is controlled by the internal self-discharge rates of the individual cells.

The cell-balancing device preferably has an IV curve that passes a current less than the cell self-discharge rate ˜C/100,000 in the 2.8 to 3.0 volt range where the cell is fully discharged. The balancing device is also designed to pass an exponentially increasing current as the voltage is increased, such that the device should pass currents on the order of C/1,000 at the maximum expected cell operating voltage of 4.1 to 4.2 volts. The maximum current carrying capability of the device needs to be no more than C/400, which corresponds to 4.0 ma for a 1.5 Ah cell and 125.0 ma for a 50.0 Ah cell. Maximum power dissipation at 4.2 volts, based on a C/1,000 rate, is 5.25 mW for a 1.5 Ah cell, and 210.0 mW for a 50.0 Ah cell. The cell-balancing device is designed to operate over a temperature range of at least −10° C. to 80° C., which covers the maximum operating temperature range of lithium ion cells with a 20° C. margin.

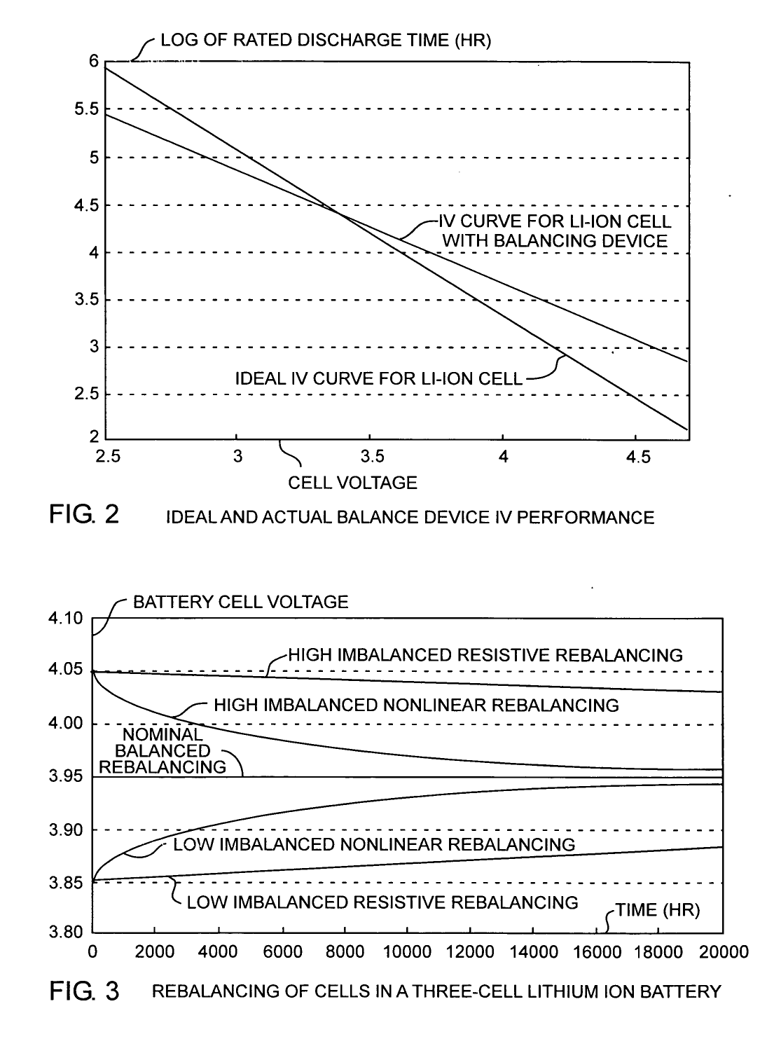

Referring to FIGS. 1 and 2, and more particularly to FIG. 2, the time required to discharge the rated capacity of a lithium ion cell is a function of cell voltage and is shown for an ideal cell without a balancing device and balanced cell having a balancing device. The operation of a balanced cell can be demonstrated by testing the balanced cell providing a balanced ideal IV curve and by testing an unbalanced cell providing an unbalanced ideal IV curve. The time required to discharge the rated cell capacity for both an ideal cell and the balanced cell are shown in FIG. 2. The balanced cell performance indicated in FIG. 2 was obtained for three precisely matched 5.2-volt zener diodes.

Referring to all of the Figures, and more particularly to FIG. 3, the rebalancing of the lithium ion cells in the three cell battery is shown to have an initial 40% state of charge imbalance during float at 11.85 volts using the balancing devices and for conventional 36K ohm resistive balancing devices connected across respective cells. An assembling of a lithium-ion battery includes three 1.25 Ah lithium ion battery cells connected in series with matched 5.2 volt zener diodes balancing devices connected in parallel with each respective cell. Each of the three balancing devices exhibited a precisely matched current behavior following that indicated in ideal IV curve. To determine the capability of this balancing system to operate, the lithium-ion cells in the battery are intentionally imbalanced. One cell was charged to 3.85 volts, one to 3.95 volts, and one cell to 4.05 volts. This gave a battery with the highest capacity cell containing approximately 40% more capacity than the lowest capacity cell. The battery was then allowed to stand at a constant voltage of 11.85 volts, which produces 3.85 volts per cell, for a one-month period. During the one-month period with a float charge of 11.85 volts, the individual cells in the battery exhibited the behavior shown in FIG. 3.

The balancing performance expected beyond one month can be obtained by a computer simulation based on the observed capacity and voltage performance of the ideal performance. Also shown in FIG. 3 is a computer simulation of the balancing performance expected when conventional 36K ohm resistor balancing devices are coupled across each respective cells in a similarly imbalanced battery during float charge. A resistance of 36K ohm provides the same loss current at 3.6 volts as does the zener diode balancing devices. The 36K ohm resistor provides linear balancing where as the zener diode balancing devices provides nonlinear balancing. The nonlinear balanced battery can maintain improved balance between cells having more than twenty times greater mismatch in internal losses than with the convention resistive balancing device. As may be apparent from FIG. 3, the nonlinear balancing of a cell provides for more rapid charge and discharge to a balanced state. The high imbalanced nonlinear rebalancing is faster than high imbalanced resistive rebalancing. Likewise, the low imbalanced nonlinear rebalancing is faster than the low imbalanced resistive rebalancing. That is, the nonlinear rebalancing asymptotically approaches the nominal rebalanced rebalancing line faster than the linear rebalancing linearly approaches the nominal rebalanced rebalancing line. As such, the nonlinear rebalances provides for improved rebalancing.

This balanced battery can be used to maintain cell balance in lithium ion batteries. The nonlinear rebalancing may improve battery life, reliability, and safety. The nonlinear rebalanced battery has no active electronic components, is light and small, dissipates negligible heat, and can maintain state of charge balance between cells having mismatched internal losses more than twenty times more effectively than can alternative resistive balancing systems, and will not discharge cells below safe levels. The nonlinear devices are preferably matched with identical IV performance characteristics. Semiconductor photolithography processes provide nearly identical operating characteristics. As such, matched thin film diodes fabricated by batch semiconductor processes are preferred, that can be applied to both discrete and thin film battery cells. Those skilled in the art can make enhancements, improvements, and modifications to the invention, and these enhancements, improvements, and modifications may nonetheless fall within the spirit and scope of the following claims.

What is claimed is:

1. A battery comprising,
battery cells having positive and negative terminals, the battery cells being connected in a serial string, and
nonlinear devices being connected in a serial string, each of the nonlinear devices having positive and negative terminals respectively coupled to the battery cells, the serial string of battery cells and serial string of nonlinear devices forming a serial string of balanced battery cells, the nonlinear devices serving to balance the voltage of the battery cells with each cell being balanced to the same balanced voltage level.

2. The battery of claim 1 wherein,
the battery cells are lithium ion battery cells.

3. The battery of claim 1 wherein,
the nonlinear devices are diodes.

4. The battery of claim 1 wherein,
the nonlinear devices are zener diodes.

5. The battery of claim 1 wherein,
the nonlinear devices are 5.2V zener diodes.

6. The battery of claim 1 further comprising,
a plurality of the serial string of balanced battery cells connected in parallel.

7. The battery of claim 1 wherein,
the nonlinear devices have matched current to voltage performance.

8. The battery of claim 1 wherein,
the nonlinear devices conduct current less than a discharge rate of the battery cells.

9. The battery of claim 1 wherein,
the nonlinear devices are fabricated by thin film processes for matching current to voltage performance.

10. The battery of claim 1 wherein,
discharge and charge rates of the battery cells when imbalanced asymptotically approach a nominal balanced state of the battery cells when balanced.

11. The battery of claim 1 wherein,
the nonlinear devices are passive devices.
